(19) United States
(12) Patent Application Publication
(10) Pub. No.: US 2016/0364688 A1
(43) Pub. Date: Dec. 15, 2016

(54) LEGAL DOCUMENT DELIVERY SYSTEM

(71) Applicant: Moshe Vakneen, Aventura, FL (US)

(72) Inventor: Moshe Vakneen, Aventura, FL (US)

(21) Appl. No.: 14/735,106

(22) Filed: Jun. 9, 2015

(51) Int. Cl. G06Q 10/08

(52) U.S. Cl. CPC G06Q 10/0833

(57) ABSTRACT

A system for facilitating delivery of legal documents has a driver GPS unit positioned near a driver vehicle configured to determine the location of the driver vehicle and transmit the location to a backoffice application through a network, a driver interface configured to show delivery job information and enable a driver to accept one or more jobs, a tenant interface, for requesting delivery of a legal document, wherein the tenant interface is configured to transmit a request to the backoffice application, and the backoffice application for processing a request, configured to provide delivery job information comprising the pickup address and destination address to the driver, and configured to provide the driver vehicle location to the tenant interface, wherein the backoffice application records a custody chain for the legal document.

### FIELD OF THE INVENTION

This invention relates to a legal document delivery system using GPS positioning and document tracking

### BACKGROUND OF THE INVENTION

Legal documents must be delivered securely and in a timely manner. In the past, legal documents were carried around the country by priority post services and expedited mail like UPS and FedEx. Within a city, legal documents were sent from one location to another by courier, either bicycle, by foot or by car/delivery van.

However, in the case of delivery within a city, a single company must be contracted to deliver the document, and there is no real time notification of delivery or the location of the delivery vehicle. In addition, it is beneficial to be able to trace the custody of the package for the entire trip, in order to prevent the document from being altered en route.

Therefore there is a need for a secure legal documents delivery system that enables real-time tracking of the package and competition between deliverers to improve service quality, that provides tracking of the document custody to ensure it is not altered.

### SUMMARY OF THE INVENTION

A system for facilitating delivery of legal documents has a driver GPS unit positioned near a driver vehicle configured to determine the location of the driver vehicle and transmit the location to a backoffice application through a network, a driver interface configured to show delivery job information and enable a driver to accept one or more jobs, a tenant interface, for requesting delivery of a legal document, wherein the tenant interface is configured to transmit a request to the backoffice application, and the backoffice application for processing a request, configured to provide delivery job information comprising the pickup address and destination address to the driver, and configured to provide the driver vehicle location to the tenant interface, wherein the backoffice application records a custody chain for the legal document.

In an embodiment, the driver interface provides delivery status information to the backoffice application. The tenant application may transmit information regarding the legal document size, and may transmit information on delaying the delivery to a later time. The tenant application may have a list of favorite drivers, and wherein the driver interface shows delivery jobs to the favorite drivers before other drivers.

A method of delivering legal documents has the steps of a tenant requesting a delivery job for a legal document, wherein job information comprising pickup location and delivery location is provided by the tenant, a driver vehicle having a GPS providing a driver location of the driver vehicle, wherein the distance from the driver vehicle to the pickup location is calculated, a plurality of driver vehicles in proximity to the pickup location are notified of the delivery job through a drivers' interface, wherein a driver accepts the job and updates delivery status as accepted, the driver picks up the document, updates delivery status as en route and delivers it to a destination, forming a trip, the custody chain is updated with the trip, and the driver updates delivery status as delivered.

The delivery status information and driver location information may be transmitted to a tenant interface. The tenant provides size information regarding the legal document size. In an embodiment, the tenant provides delay information on delaying the delivery to a later time, and wherein the driver delays delivery in accordance with the delay information. The tenant may provide a list of favorite drivers, and the driver vehicles of favorite drivers may be notified before other driver vehicles.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a functional diagram showing the functional blocks of the tenant application, the driver application, and the backoffice application.

### DETAILED DESCRIPTION OF PREFERRED EMBODIMENTS

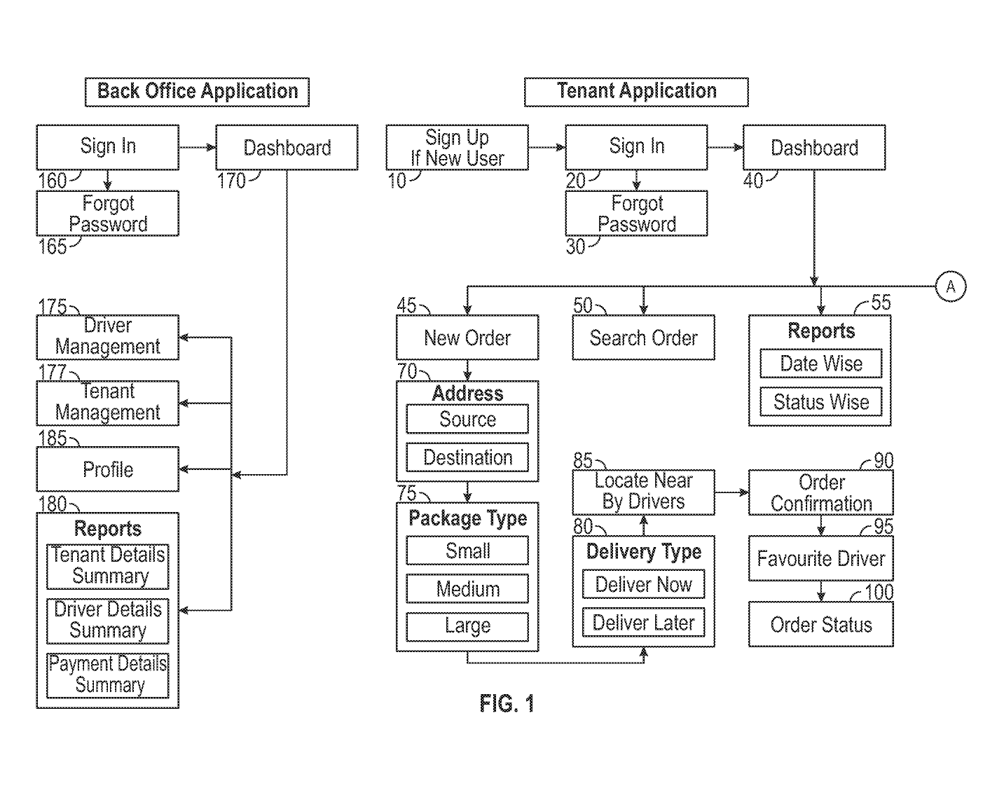

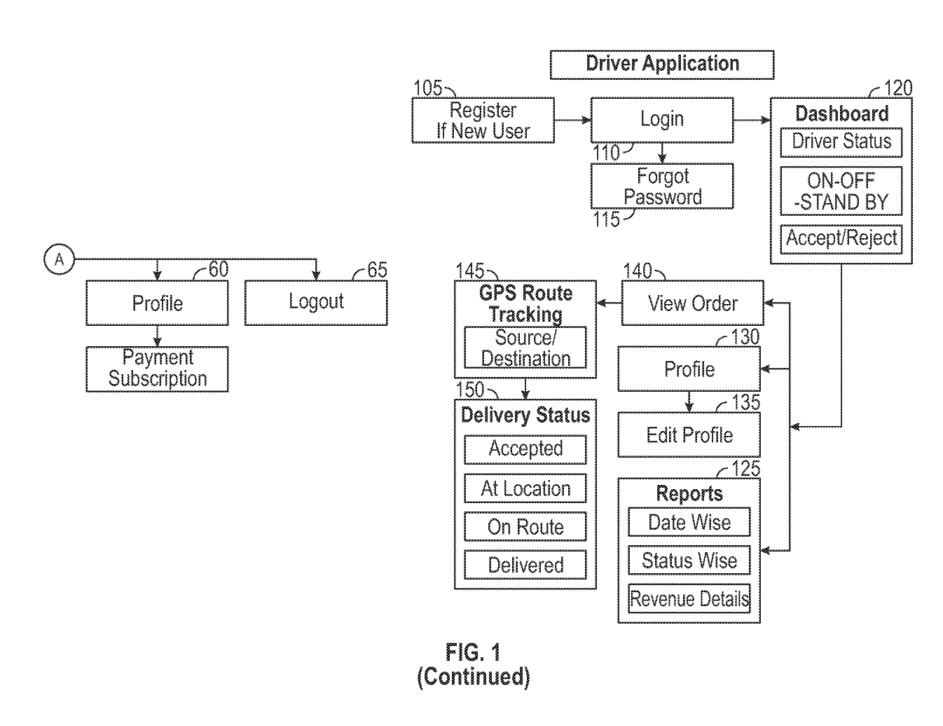

Preferred embodiments of the present invention and their advantages may be understood by referring to FIG. 1 wherein like reference numerals refer to like elements.

With reference to FIG. 1, the tenant application has a sign up step 10 and a sign in step 20 for an existing user, to uniquely identify a user. A typical user would be a law firm, which, in an embodiment, would provide a company name, address, first and last name of a contact person as well as email, password and phone number. Once signed up, a verification email is sent to the user to verify the email address, and the user can edit their information. The user has a recovery procedure for a forgotten password at step 30, such as entering an email wherein the password is sent to the email, or wherein a password reset link is sent. The user then receives a dashboard view at 40, which provides options of initiating a new order 45, searching existing orders at 50, reports on order at 55, editing or managing the user profile at 60, and a logout at 65.

After successful login, the Dashboard screen is provided to users. From the dashboard, the user may create an order at step 45, and will provide i) the source and destination address for the driver to pickup and deliver the package, ii) the size of the package, iii) the type of delivery including time of delivery (today or at a later date, user to provide date). Further, a user may iv) trace nearby drivers based on geographical location, and v) choose a driver (wherein an alert is sent to the driver who accepts or rejects it) and assign the order. The user may initiate a new order in step 45, wherein the application receives sufficient information to instruct a driver to pick up and deliver the package. In step 70, the source and destination addresses are provided for the delivery. The source destination may be automatically selected as the current location of the user. The destination address may be limited to a legal jurisdiction or within a defined territory (state, etc.) In step 75, the package size and/or type is selected, wherein the package may be small, medium, large or oversize (or other meaningful divisions based on size) or may be a box, a binder or an envelope (or other types of package and breakdowns thereof). In step 80, the delivery time may be specified, for example as soon as possible, or a time-delayed delivery (for example, next Tuesday, or after the first of the month). Once the details of the package to be delivered have been ascertained, in step 85 drivers are located. Each driver has a GPS unit in the vehicle that is constantly reporting on the location of the vehicle. Several vehicles that are closest to the package are notified to the nature of the delivery (package, pickup and destination locations) and the first to acknowledge and accept the delivery is allocated the delivery. The user may select a preferred driver out of a list of available (proximal) drivers. The user may simply also choose the nearest driver to result in the fastest delivery. The remaining drivers lose the option of accepting the delivery. Once the driver accepts, an order confirmation is sent to the driver at step 90 and the remaining drivers lose their chance to accept the order. A favorite driver is selected at step 95, wherein the driver may be added to a “favorites list” of delivery drivers for the user to select from first or preferentially request. Further, drivers may be removed from the favorites list, as desired by the user. If a driver is on the favorites list, he or she receives the first notification, and has a chance to accept/reject before the notification passes to other drivers. In step 100, the order status is provided to the user and may be tracked by the user as it is being updated. The GPS receiver of the driver's car transmits its position to the app, which relays the information in real time so the user can monitor the location of the package.

With reference to FIG. 1, in step 50 the users may search their orders and receive order status for each order. Filtering and sorting options may be provided to facilitate the search process. In step 55, reports may be generated to provide information on the overview of the orders, for example by date or status. Examples of reports are a i) date wise report, wherein a user may review all orders within a date range, and a ii) status wise report providing users with the capability to track their orders based on status (delivered, pending etc.) In step 60, the user may view their profile and modify key items, including user id and password, as well as brief description and a photo or logo. They may also adjust payment information through the profile step 75. In step 62, payment subscription information and selection may be viewed and altered, and payment means may be changed, added or removed.

With reference to FIG. 1, the driver application is shown. In step 105, the driver may register, and in step 110, the driver may login, so as to identify the drivers uniquely. To register, a driver would provide his or her name, email and a password. In addition, a phone number, date of birth, city, state, zip code, profile (about me), license number and expiry date, vehicle insurance information and expiry date, license and vehicle insurance images, vehicle images and profile pictures may be added. Furthermore, the information comprises whether the driver is certified in his state to serve legal documents. In step 107, the vehicle insurance and driver license and identity are verified, along with a potential background check. If yes, then that license information and State may be stored. If the driver has been referred by an existing driver, the MLD or Reference ID is stored. The driver may edit his or her profile when necessary. Once the account is verified and the background check is complete, the driver is authorized to login to the system. If the driver has forgotten his or her password, there is a password reset at step 115. In step 120, the driver is presented with a dashboard, which provides a driver status indicator, showing for example, ON, OFF or STAND BY. If the driver's status is ON, then if any favorite drivers are available, they would receive the alert first. If they fail to respond, then other drivers with the ON status would receive the alert. If the driver's status is on STAND BY, the driver receives orders only when no drivers have an ON status, or no drivers with an ON status reply within certain period of time. If the driver's status is OFF, the drivers would not receive order messages. The driver dashboard also allows drivers to accept or reject driving orders that are offered.

A single driver can take multiple packages at once, wherein the dropoff and pickup points are approximately along the same line. The backoffice optimizes the route for security and efficiency based on time to destination and the windows of time for dropping off documents and picking them up.

In step 125, the driver may view reports on the driving orders, and may sort by date, status, or revenue details. Examples of reports would be i) a date wise report that provides orders accepted and /or delivered over a specific date range, ii) a status wise report that provides drivers with the capability of tracking orders based on order status (delivered pending, etc.), or iii) current revenue details for date ranges, geographies, etc. In step 130, the driver may access his or her profile, and in step 135, may edit the profile. The profile may contain information like the driver's name and address, account information and biography or driving record, and driver's license and/or payment account information. In step 140, the orders can be viewed, including details on GPS route tracking by source and destination in step 145. For example, the source and destination address would be provided as hyperlinks, which, when clicked, would open into a route map for the driver based on the current locality of the driver. Based on the address that the driver clicks, the GPS route tracking would be enabled and would display the route to the destination based on current location. Drivers can accept or reject orders that they receive. A driver may accept multiple orders after consideration of the timeframe for delivery and source/destination location. After an order is accepted, the status may change to PICK UP indicating the package has been picked up, ON ROUTE, indicating the driver is currently driving to the destination, or DELIVERED, indicating the package has arrived at the final destination and has been signed off on by the recipient (if applicable). In step 150 delivery status may be viewed, namely whether the order has been accepted, the driver is at location, en route or the package is delivered. Order details such as order number, order date, source address, destination address, delivery type and package type for a particular order may be viewed.

The Back Office application links both the tenant application and the driver application, and provides information on current orders (deliver today) and future orders (deliver later). The fields shown in association with the dashboard are order number, order date, deliver date, company name, driver name, pickup address, delivery address and order status. It may be accessed by an administrator in order to manage the system. It has a sign in procedure at step 160, and a forgot password procedure at step 165, wherein an administrator can reset their password. Once signed in, the user or driver accesses a dashboard at step 170. The dashboard presents a driver management console at step 175, which provides access to manage driver's user ids and passwords, as well as giving the ability to add or delete a driver. The driver list can be searched, and may include driver name, address, city, state, email address, phone number and current status, along with filtering and sorting. The driver's console also maintains information on revenue as well as referral bonuses (paid out to drivers for referrals of new drivers, and accrued in the console view). A tenant management console at step 177 enables management of tenants, for example user ids and passwords as well as the ability to add or delete a user, and change payment/subscription details. Also in the tenant management is the ability to search the list of registered users, wherein the fields may include company name, address, first and last name of contact, email address and phone number. Filtering and sorting options would be available. The pricing details are managed through the administrative console, as well as any referral bonuses that are applicable for the user referring other users or drivers. At step 180 reports are available such as a tenant details summary, driver details summary, and payment details summary. The reports may contain the order number, order date, deliver date, company name, driver name, pickup address, deliver address and order status, for both current and future orders, with filtering and sorting options to be provided for user friendliness. There is an option for at-a-glance tenants details summary, driver details summary, and payment details summary providing full payment details. In step 185 the administrator may manage the administrator profile. There may be an option for “God view” that shows the administrator the location of all drivers and packages simultaneously, to see the working of the entire system.

In an embodiment, custody chain tracking features are present, wherein the backoffice saves the GPS position of the driver having the document to know where the document is at all times. The document may also be sealed by the pickup driver and the delivering driver is required to deliver the document with the seal intact. A certified route may also be sent to the driver to follow in the delivery to ensure there are no interruptions in the delivery. Once the document is delivered, an electronic signature is stored in the backoffice along with the name and identity of the signer.

With reference to FIG. 1, in an embodiment, the tenant or user application is web-based or mobile-based, while the driver application would be predominantly mobile-based. The back office may reside on a server and would be web-based to interface with both the tenant and driver applications.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1) A system for facilitating delivery of legal documents, comprising:
a) a driver GPS unit positioned near a driver vehicle configured to determine the location of the driver vehicle and transmit the location to a backoffice application through a network;
b) a driver interface configured to show delivery job information and enable a driver to accept one or more jobs;
c) a tenant interface, for requesting delivery of a legal document, wherein the tenant interface is configured to transmit a request to the backoffice application; and
d) the backoffice application for processing a request, configured to provide delivery job information comprising the pickup address and destination address to the driver, and configured to provide the driver vehicle location to the tenant interface, wherein the backoffice application records a custody chain for the legal document.

2) The system of claim 1, wherein the driver interface is configured to provide delivery status information to the backoffice application.

3) The system of claim 1, wherein the tenant application is configured to transmit information regarding the legal document size.

4) The system of claim 1, wherein the tenant application is configured to transmit information on delaying the delivery to a later time.

5) The system of claim 1, wherein the tenant application is configured to have a list of favorite drivers, and wherein the driver interface shows delivery jobs to the favorite drivers before other drivers.

6) A method of delivering legal documents, comprising the steps of:
a) a tenant requesting a delivery job for a legal document, wherein job information comprising pickup location and delivery location is provided by the tenant;
b) a driver vehicle having a GPS providing a driver location of the driver vehicle, wherein the distance from the driver vehicle to the pickup location is calculated;
c) a plurality of driver vehicles in proximity to the pickup location are notified of the delivery job through a drivers' interface, wherein a driver accepts the job and updates delivery status as accepted;
d) the driver picks up the document, updates delivery status as en route and delivers it to a destination, forming a trip;
e) the custody chain is updated with the trip; and
f) the driver updates delivery status as delivered.

7) The method of claim 6, wherein the delivery status information is transmitted to a tenant interface.

8) The method of claim 6, wherein driver location information is transmitted to a tenant interface.

9) The system of claim 6, wherein the tenant provides size information regarding the legal document size.

10) The system of claim 6, wherein the tenant provides delay information on delaying the delivery to a later time, and wherein the driver delays delivery in accordance with the delay information.

11) The system of claim 6, wherein the tenant provides a list of favorite drivers, and wherein driver vehicles of favorite drivers are notified before other driver vehicles.
